(19) United States
(12) Patent Application Publication
(10) Pub. No.: US 2022/0082122 A1
(43) Pub. Date: Mar. 17, 2022

(54) CONNECTING ELEMENT FOR A PIECE OF FURNITURE, PLUG-IN SYSTEM COMPRISING SUCH A CONNECTING ELEMENT AND METHOD OF ASSEMBLING A PIECE OF FURNITURE

(71) Applicant: Stefan Diez, München (DE)

(72) Inventor: Stefan Diez, München (DE)

(21) Appl. No.: 17/474,397

(22) Filed: Sep. 14, 2021

(30) Foreign Application Priority Data
Sep. 14, 2020 (DE) 10 2020 123 839.8

(51) Int. Cl. F16B 12/32

(52) U.S. Cl. CPC F16B 12/32

(57) ABSTRACT

Connecting element for a piece of furniture for connecting a first furniture component, for example a side wall, to a second furniture component extending obliquely to the first furniture component, for example a shelf support or a shelf, without additional material-locking means and without additional fastening means, including: a first functional section for a first snap-in device which, in the assembled state, forms a first form-fit of the connecting element with the first furniture component, a second functional section for a second snap-in device which, in the assembled state, forms a second form fit of the connecting element with the second furniture component, a receiving area in which, in the assembled state, a section of the second furniture component is received, and a third functional section for a third snap-in device which, in the assembled state, forms a third form fit of the connecting element with a cladding element which covers the receiving area at least partially, preferably completely, towards a visible side of the piece of furniture, and/or a fourth functional section for a fourth snap-in device which, in the assembled state, fixes a rear wall of the piece of furniture.

### CROSS REFERENCE TO RELATED APPLICATION

This application is related to and claims the benefit of German Patent Application Number 10 2020 123 839.8 filed on Sep. 14, 2020, the entire contents of which are incorporated by reference herein.

### TECHNICAL FIELD

The present disclosure relates to a connecting element for a piece of furniture, a plug-in system comprising such a connecting element and a method of assembling a piece of furniture.

In particular, the present disclosure relates to a connecting element for a piece of furniture, with which furniture components can be connected to one another without additional fastening means, such as screws or bolts, or material-locking means, such as glue or adhesive. Thereby, such a connecting element primarily serves to join or connect a first furniture component and a second furniture component to each other. For example, the furniture component is a shelf assembled from side panels and shelf boards or shelves using the connecting element.

### BACKGROUND

From the publication WO 2014 146 979, such connecting elements are known in which a connection is made from the connecting element to a first furniture component and a second furniture component via snap-in connections in each case, in order to connect the first furniture component to the second furniture component via the connecting element. In this case, the connecting element is arranged in the interior of the first furniture component and the second furniture component and thereby interacts with solid core regions of the first furniture component and the second furniture component.

### BRIEF SUMMARY

The present disclosure provides a connecting element for connecting the first furniture component and the second furniture component which is as simple and versatile as possible, and in particular also permits use in furniture components which are designed as light-weight components, i.e. are free from a solid material region in the furniture component. In addition, the cladding element should be hardly or not at all visually perceptible in the installed state.

According to a first aspect of the present disclosure, a connecting element for a piece of furniture for connecting a first furniture component, for example a side wall, to a second furniture component extending obliquely to the first furniture component, for example a shelf support and/or a shelf, is provided without additional material-locking means and without additional fastening means, comprising:
a first functional section for a first snap-in device which, in the assembled state, forms a first form-fit of the connecting element with the first furniture component,
a second functional section for a second snap-in device which, in the assembled state, forms a second form-fit of the connecting element with the second furniture component,
a receiving area in which, in the assembled state, a section of the second furniture component is received, and
a third functional section for a third snap-in device which, in the assembled state, forms a third form fit of the connecting element with a cladding element which covers or covers the receiving area at least partially, preferably completely, on a visible side of the piece of furniture, and/or a fourth functional section for a fourth snap-in device which, in the assembled state, fixes a rear wall of the piece of furniture.

Compared to the connecting elements known from the prior art, in addition to the first functional section and the second functional section, which serve to connect the first furniture component to the second furniture component, a third functional section and/or a fourth functional section is provided, with which a cladding element or a rear wall can be connected to the connecting element. Thus, the connecting element according to the disclosure has an additional task in addition to connecting the first furniture component to the second furniture component, whereby the functionality of the connecting element is increased in an advantageous manner compared to the connecting elements known from the prior art.

Particularly preferably, it is provided that the first furniture component and the second furniture component are aligned substantially perpendicular to each other, as is the case, for example, with a shelf and a supporting side wall of a shelf. In particular, it is provided that the connecting element is configured, for example by a corresponding alignment of the first functional section, the second functional section, the third functional section and/or the fourth functional section, such that the first furniture component and the second furniture component extend perpendicularly to each other and the cladding element extends parallel to the path of the first and/or second furniture component. In this case, the second furniture component is inserted into the receiving area along a plug-in direction. Furthermore, it is preferably provided that the form fit of the first snap-in device, the form fit of the second snap-in device, the form fit of the third snap-in device and/or the form fit of the fourth snap-in device act in directions which run parallel to one another, particularly preferably parallel to the plug-in direction. For example, the cladding element is an edging.

In particular, it is provided that, in the assembled state of the connecting element, the receiving area is set back from the visible side of the piece of furniture with respect to the third functional section as viewed in a direction parallel to the plug-in direction. As a result, the cladding element attached to the third functional section can cover the connecting element and the receiving area by extending over the connecting element and the receiving area on the visible side of the piece of furniture. The receiving area preferably surrounds the received section of the second furniture component on three different sides.

Therefore, it proves advantageous to attach the cladding element to the connecting element via the third functional section, because this covers the connecting element and in particular the receiving area of the connecting element. Consequently, it is advantageously possible to cover with the connecting element, in particular its third functional section which fixes the cladding element to the connecting element in a fixed direction or orientation, the area in which the second furniture component is received, as well as corresponding partial areas of the connecting element which would otherwise be visible on the visible side of the piece of furniture.

In particular, it is provided that the connecting element is designed to be inserted along the plug-in direction into a corresponding recess on one side of the first furniture component until a form fit is achieved between the connecting element and the first furniture component via the first snap-in connection. The inserted connecting element then has a receiving area which is open towards the visible side and over which the section of the second furniture component can be inserted, in particular until the second functional section interacts positively with a corresponding profile of the second furniture component after it has engaged. In particular, the receiving area has a mouth-like or pot-shaped configuration. To this end, the receiving area has a U-shaped basic shape in the region which, in the assembled state, engages in the first furniture component or is recessed in the first furniture component.

Furthermore, it is particularly preferably provided that the cladding element is U-shaped and embraces an end section of the first furniture component facing the visible side of the piece of furniture in the assembled state. This end section, which faces the visible side of the piece of furniture, projects towards the visible side with respect to a front side of the second furniture component received in the receiving area. By placing or pushing the cladding element onto the end section, the end section is thus embraced by the cladding element and the connecting element hits the front side of the second furniture component which is located on the outside and/or faces the visible side. In particular, the open end of the U-shaped cladding element abuts the second furniture component. By inserting the second furniture component into the receiving area and subsequently attaching the cladding element, the connecting element is preferably covered towards the visible side by the cladding element and the second furniture component. For fixing the cladding element, it is in particular provided that the connecting element comprises a third functional section via which a snap-in connection to the inner side of the cladding element is established. In a corresponding manner, the cladding element with its U-shaped course has a curved or notched course on its inner side, which in the assembled state interacts positively with the third functional section of the connecting element.

In particular, by a snap-in device or a corresponding functional section it is to be understood that the respective portion is elastically deformable on the connecting element and, in particular, is profiled in such a way that it can cooperate in a form-fitting manner with a corresponding complementarily shaped contour, in particular after a snap-in movement during assembly. Preferably, it is provided that the first functional section for forming the first snap-in device is arranged on the connecting element in such a way that the first snap-in device is formed in the end section of the first furniture component, whereby the first functional section can be covered or masked by the cladding element in the assembled state. Furthermore, it is preferably provided that the end section of the first furniture component tapers towards the visible side or front side, in particular with respect to its width. Preferably, the side walls of the cladding element merge flush with the top walls of the first furniture component in the assembled state in which the cladding element embraces the end section. This is in particular favored or caused by a correspondingly tapering or tapered course of the end section of the first piece of furniture. In particular, it is provided that the snap-in devices are detachably connectable to the first furniture component, the second furniture component, the rear wall and/or the cladding element in order to dismantle the piece of furniture as non-destructively and easily as possible.

Furthermore, it is particularly preferably provided that the first furniture component and/or the rear wall is formed as a lightweight component in which two opposing and parallel cover walls are spaced apart from each other by corresponding transverse struts. Preferably, the transverse struts form a honeycomb, diamond, rectangular and/or square pattern. Hollow spaces are formed between the individual transverse struts, thereby providing a comparatively light-weight component, in particular compared to such components which are solid. Preferably, it is provided therein that in order to form the first snap-in device, corresponding recesses and/or recessed cover wall contour courses are provided at the outermost edge of the cover walls, whereby, on the one hand, a reception of the connecting element in the first furniture component is permitted and, on the other hand, a snap-in connection between the first functional section and the corresponding contour of the cover walls is realized in order to realize the form fit between the first furniture component and the connecting element. Preferably, the first functional section is formed as an outer contour or projection on the connecting element.

Preferably, the second functional section is arranged in the receiving area, in particular at the bottom of the U-shaped base course of the receiving area and/or at a bottom of the U-shaped course of the receiving area opposite the opening. As a result, it is advantageously possible to receive the second furniture component and/or the section of the second furniture component in the receiving area and, in particular, to displace it along a plug-in direction until a form fit is established between the second furniture component and the second functional section. For example, the second furniture component can be guided along the inner side of the receiving area until the second furniture component engages with the second functional section.

Preferably, the second furniture component is supported by the connecting element in the assembled state, for example by the second furniture component resting on an inner side of the receiving area. In this regard, it is preferably provided that the receiving area has a depth dimensioned in the plug-in direction which is greater than a depth of the section of the second furniture component which is to be inserted into the receiving area during assembly. In particular, it is approximately twice as large and/or as deep as the received area of the second furniture component. In this way, it is advantageously possible for an end section of the first furniture component or a section of the connecting element to project in the assembled state with respect to a front side or side wall of the second furniture component, in order to create a connection with the projecting end area of the first furniture component to the cladding element, with which in turn the cladding element and the end section can be covered. In this way, a visually appealing visible side of the piece of furniture can be realized with the plug-in system, in which the connecting element is not visually perceived as a disturbing point.

Preferably, it is provided that the connecting element is substantially T-shaped. This makes it advantageously possible to place the third and/or fourth functional section on sides of the connecting element facing the visible side, while the first functional section and the second functional section are set back into the interior of the first furniture component relative to the third and fourth functional sections in the assembled state. Preferably, the third functional section and the fourth functional section are arranged at the same height when viewed in the plug-in direction. In particular, it is provided that the third functional section and/or the fourth functional section are arranged on both sides, i.e. on opposite sides of the receiving area (viewed in a direction which is parallel to the main plane spanned by the T-shaped course of the connecting element and perpendicular to the plug-in direction), in particular adjacent to both sides of the U-shaped section of the receiving area, in order to realize a force effect on the cladding element and/or the rear wall which is as symmetrical as possible.

Furthermore, it is preferably provided that the fourth functional section is configured to engage hollow spaces of the rear wall in the assembled state, in particular hollow spaces provided by a rear wall provided as a lightweight component.

Preferably, it is provided that the connecting element is integrally formed, in particular is made of a plastic and/or a steel sheet. By integral or one-piece it is to be understood in particular that the connecting element cannot be dismantled non-destructively into further components. In particular, as a plastic component, the connecting element can be manufactured comparatively easily, for example by an injection molding process.

Preferably, it is provided that the first functional section and/or the second functional section comprises at least one bracket-like arm section, preferably exactly one bracket-like or handle-like arm section. In particular in the case of the second functional section, it is conceivable that only a single bracket-like arm section is provided, since the receiving area additionally serves as a bearing for the received second section of the second furniture component and thus supports the carrying of the second furniture component. A fixation of the second furniture component by the snap-in device for preventing an up and down movement of the second furniture component can further be realized by the second functional section at the connecting element. In particular, it proves to be advantageous because thereby the second furniture component is pressed onto one side in the receiving area by the one-sided formation of the bracket-like element, thereby preventing the second furniture component from being arranged in the receiving area with play, which would otherwise lead to the second furniture component resting loosely in the receiving area. For this purpose, a corresponding restoring force in the elastically deformable arm portion of the second functional section presses in particular the second furniture component in the assembled state against an inner side of the receiving area of the connecting element. This proves to be particularly advantageous in the case of the comparatively light shelves

Preferably, it is provided that the section of the second piece of furniture to be received is insertable into the receiving area along a plug-in direction during assembly, wherein the second functional section on the one hand and the third functional section and/or the fourth functional section on the other hand are offset to one another in a direction running parallel to the plug-in direction and in a direction running perpendicular to the plug-in direction. The staggered arrangement of the different snap-in devices proves to be advantageous in particular because the formation of connection areas staggered in the plug-in direction ensures the connection of the first furniture component, the second furniture component and the cladding element, in particular in such a way that it is possible to cover the connecting element with the cladding element.

Preferably, it is provided that the connecting element comprises a centering aid for the second furniture component, wherein the centering aid is preferably formed in the second functional section. For example, it is a dome-shaped or tapering projection on the face side of the second functional section, which engages in a corresponding first recess in the second furniture component in order to establish an alignment in the lateral direction or sideways direction of the second furniture component during assembly. In particular, in the assembled state, the projection in the form of the centering aid which passes through the first cutout also secures the second furniture component with respect to a lateral offset which is substantially perpendicular to the plug-in direction and/or the main plane of the connecting element which is defined by the T-shaped profile.

The disclosure also provides a plug-in system for assembling a piece of furniture, comprising
a first furniture component,
a second furniture component,
a cladding element, and
a connecting element according to the disclosure, in particular a connecting element according to the disclosure which is separate from the first furniture component and the second furniture component,
a first snap-in device which, in the assembled state, forms a form fit between the connecting element and the first furniture component,
a second snap-in device which, in the assembled state, forms a second form fit between the connecting element and the second furniture component,
a receiving area in which, in the assembled state, a section of the second furniture component is received, and
a third snap-in device which, in the assembled state, forms a form fit of the connecting element with a cladding element which covers the receiving area at least partially, preferably completely towards a visible side of the piece of furniture, and/or a fourth snap-in device which, in the assembled state, fixes a rear wall of the piece of furniture. All the properties and advantages described for the connecting element can be transferred analogously to the plug-in system and vice versa.

It is further provided that the first furniture component for forming a lightweight component has two cover walls for forming a lightweight component, between which hollow spaces are formed, in particular between transverse struts which connect the two cover walls to one another, wherein the first functional area of the first snap-in connection interacting with at least one of the two cover walls in a form-fitting manner in the assembled state. For example, it is a lightweight component with transverse struts that form a honeycomb shape.

The present disclosure also provides a method for assembling a piece of furniture, wherein a connecting element according to the disclosure is used for connecting a first furniture component and a second furniture component. All advantages and properties described for the connecting element can be transferred analogously to the method and vice versa.

### BRIEF DESCRIPTION OF THE DRAWINGS

Further advantages and features will result from the following description of preferred embodiments according to the disclosure with reference to the attached figures. Individual features of the individual embodiment can be combined with each other within the scope of the disclosure.

It is shown in:

FIG. 1a/b: a plug-in system according to a first exemplary embodiment of the present disclosure in a first variant and in a second variant,

FIG. 2: a connecting element according to a second exemplary embodiment of the present disclosure in a perspective view

FIG. 3: the connecting element of FIG. 2 in assembled condition,

FIGS. 4a, 5a, 6a, 7, 8a and 9: a method of assembling a piece of furniture according to an exemplary embodiment of the present disclosure according to a first variant, and

FIGS. 4b, 5b, 6b, 7, 8b and 9: a method of assembling a piece of furniture according to an exemplary embodiment of the present disclosure according to a second variant, and

### DETAILED DESCRIPTION

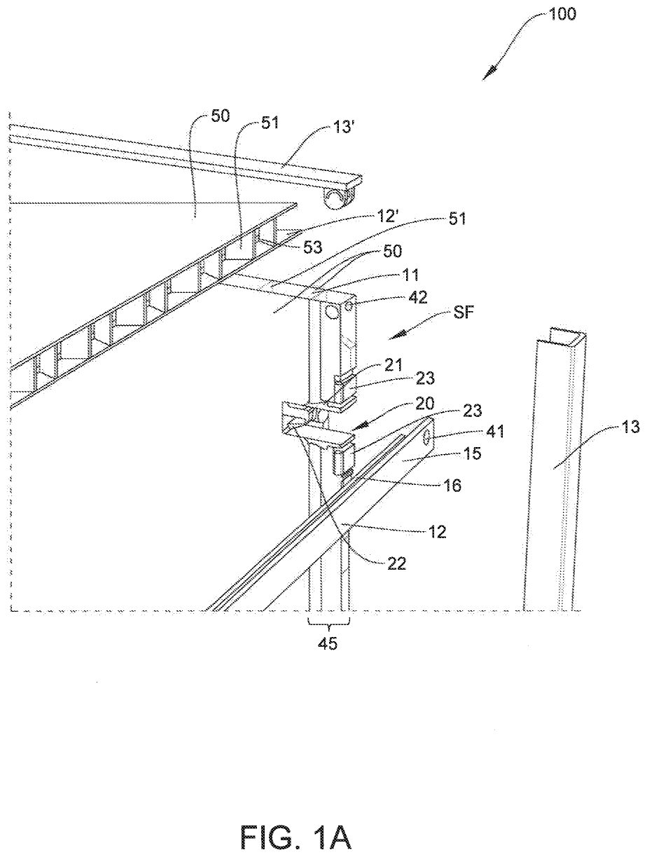

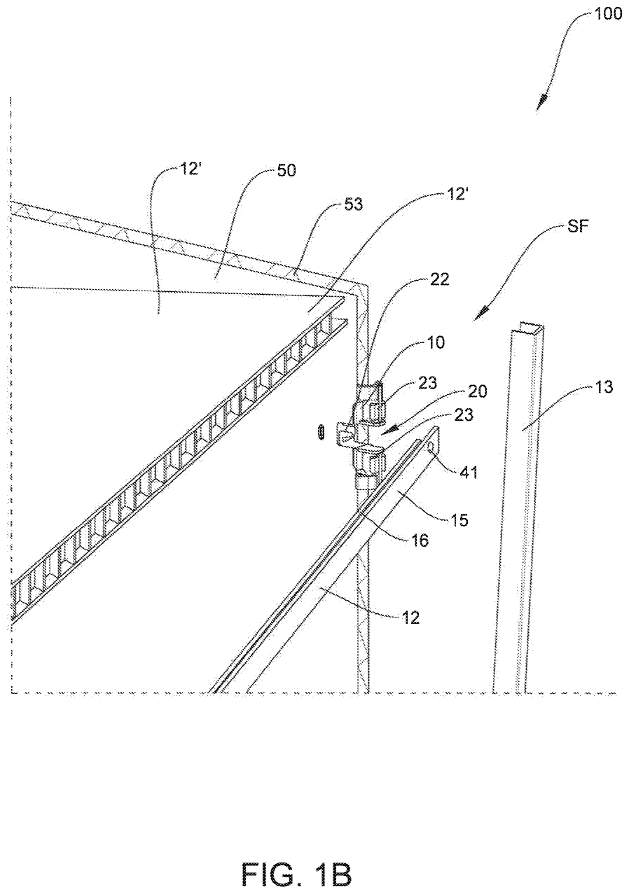

In FIG. 1a, a plug-in system 100 for assembling a piece of furniture according to a preferred embodiment of the present disclosure is illustrated in a kind of exploded view. In particular, the piece of furniture illustrated in FIG. 1a is a shelf in which, in the assembled state, a first furniture component 11, for example a side wall of the shelf, is connected to a second furniture component 12, for example a shelf support or a shelf, by means of the plug-in system 100. In the example shown in FIG. 1a, the second furniture component 12 is a shelf support in the form of a rail, in particular an L-shaped rail or a rail with a front side 15 and a rear side 16. The second furniture component 12, which is in the form of a rail, is connected to the first furniture component 11, which is a side wall in FIG. 1a, via a connecting element 10, in order to form a support surface for a shelf or shelf board 12′.

In particular, the plug-in system 100 is such a plug-in system 100 in which light-weight components are used as furniture components. For example, it is conceivable that the shelf 12′ and/or the first furniture component 11 formed as a side wall is a lightweight component. To form a lightweight component, the first furniture component 11 and/or the shelf 12′ comprises two cover walls 50 extending parallel to each other and separated from each other by transverse strut 51. The transverse struts 51 are arranged such that hollow spaces are formed between the two cover walls 50, whereby comparatively lightweight first furniture component 11 and/or shelves 12′ can be used for assembling the piece of furniture in the piece of furniture. In particular, it is provided that the rail-shaped second furniture component 12 has a front side 15 facing a visible side in the assembled state, and a rear side 16 opposite this front side 15 when viewed in the plug-in direction in the assembled state, which rear side 16 is shorter than the front side 15 facing the visible side. In the assembled state, this shorter rear side 16 of the rail-shaped second furniture component 12 engages, in the embodiment shown, in a corresponding groove 53 in the shelf 12′, the groove extending, in particular, on an underside of the shelf 12′ and preferably being formed by an interruption in one of the cover walls 50 and cutouts in the transverse struts 51.

For joining the first furniture component 11 to the second furniture component 12, a connecting element 10 is provided which is insertable or pluggable, preferably concealable, into a provided cutout 54 in the first furniture component 11 at its outer periphery, preferably forming a flush closure to the visible side. In order to avoid the use of material-locking means, such as glue or other adhesive, and further fastening means, such as screws, bolts or the like, it is provided that the plug-in system 100 comprises a first snap-in device 31 and a second snap-in device 32. In this regard, the first snap-in device 31 serves to form a form fit between the first furniture component 11 and the connecting element 10, and the second snap-in device 32 serves to form a form fit between the connecting element 10 and the second furniture component 12. In order to form the first snap-in device 31 and the second snap-in device 32, the first furniture component 11, the second furniture component 12 and the connecting element 10 are provided in the corresponding areas with a matching course on their outer surface.

The connecting element 10 has a first functional section 21 for forming the first snap-in device 31 and a second functional section 22 for forming the second snap-in device 32. The first functional section 21 and the second functional section 22 are, in particular, elastically formed and are elastically deformed during assembly for a latching or snapping movement to form the respective form fit. By the form fit between the first functional section 21 and the first furniture component 11 and/or between the second functional section 22 and the second furniture component 12 is meant, in particular, that form fit which is created after a latching or snapping movement during assembly of the plug-in system 100.

Furthermore, it is provided that the connecting element 10 comprises a receiving area 20 in which the second furniture component 12 can be inserted or pushed in during assembly, in particular in order to countersink it in the connecting element 10. In particular, the second furniture component 12 is supported in the receiving area 20 in the assembled state by resting on the connecting element 10 in the receiving area 20. To form the receiving area 20, the connecting element 10 is provided with a U-shaped section into which a section of the second furniture component 12 can be inserted. Therein, an opening of the U-shaped section faces in particular the visible side in the assembled state of the connecting element 10. Therein, it is particularly provided that a length of the receiving area 20 dimensioned in the plug-in direction S is greater than a length of the section of the second furniture component 12 received by the receiving area 20 dimensioned in the same direction. As a result, the second furniture component 12, in particular its front side 15, is arranged set back relative to a face side St of the first furniture component 11 facing the visible side. In particular, it is provided that the first furniture component 11, for example formed as a side wall, comprises an end section 45 in which the first furniture component 11 preferably tapers or is tapered by reducing a distance between the cover walls 50. In the assembled state, the end section 45 protrudes in a direction parallel to the plug-in direction S with respect to the section of the second furniture component 12 received in the receiving area 20. In other words, the end section 45 protrudes in a direction parallel to the plug-in direction S with respect to the section of the second furniture component 12 received in the receiving area 20, in particular the front side 15 thereof.

It is further provided that the form fit of the connecting element 10 to the first furniture component 11 and the form fit of the connecting element 10 to the second furniture component 12 act in a common form fit direction, which runs in particular parallel to the plug-in direction S along which the connecting element 10 is inserted into the first furniture component 11 and/or along which the second furniture component 12 is inserted into a receiving area 20 of the connecting element 10 during assembly.

In particular, it is provided that the second functional section 22 cooperates with the in particular shorter rear side 16 of the rail-like second furniture component 12 to form the second snap-in device 32, so that the form fit is formed between the shorter rear side 16 of the second furniture component 12 and the second functional section 22 of the connecting element 10, by means of which the second furniture component 12 is fixed to the connecting element 10 in the assembled state. In a corresponding manner, the shorter rear side 16 of the second furniture component 12 interacts positively both with the connecting element 10, in particular its second functional section 22, and with the shelf 12′, in particular the groove 53 on the underside of the shelf 12′.

Furthermore, it is preferably provided that the end section 45 of the first furniture component 11 is sheathed or enclosed by a cladding element 13. For this purpose, it is in particular provided that the cladding element 13 is substantially U-shaped, preferably with legs of equal length, and in particular in the assembled state encases the end section 45 of the first furniture component 11 facing the visible side. In this respect, it is preferably provided that the cladding element 13 adjoins or abuts with the open ends of the U-shaped course of the cladding element 13 against the second furniture component 12 received by the receiving area 20, in particular against the front side 15 thereof. In this way, it is advantageously possible to cover the connecting element 10 and the end section 45 with the cladding element 13 and with the second furniture component 12, so that it is no longer visible on the visible side.

Preferably, it is provided for this purpose that, in the embodiment example shown in FIG. 1a, the first functional section 21 for forming the first snap-in device 31 is designed in such a way that, in the assembled state, it is arranged in the end section 45 of the first furniture component 11. As a result, the first snap-in device 31 is advantageously covered or disguised by the disguising element 13.

It is further provided that the connecting element 10 is substantially T-shaped, and the receiving area 20 facing the visible side in the assembled state for receiving a section of the second furniture component 12 is integrated in the portion of the T-shaped course extending parallel to the mirror axis of the T-shaped basic course.

It is further provided that the connecting element 10 comprises a third functional section 23 for forming a third snap-in device 33, the third snap-in device 33 serving to attach the cladding element 13 to the connecting element 10. As a result, in addition to the task of joining or connecting the first furniture component 11 and the second furniture component 12, the connecting element 10 also has the task of fixing the cladding element 13 with which the connecting element 10 is to be concealed or covered in the assembled state. This proves to be advantageous in particular because it means that only a single component is required with which the first furniture component 11, the second furniture component 12 and the cladding element 13 can be connected to one another.

The second variant illustrated in FIG. 1b differs from the first variant essentially only in that an end portion 43 is dispensed with. In this case, the connecting element 10, in particular its third functional section 23 and fourth functional section 24, protrudes with respect to the face side St of the first furniture component 11. In particular, the section of the connecting element 10 extending transversely to the plug-in direction rests on the face side St of the first furniture component 11. In this second variant, the third furniture component 13 embraces a free area which, in the first variant, is formed by the tapered end section 43.

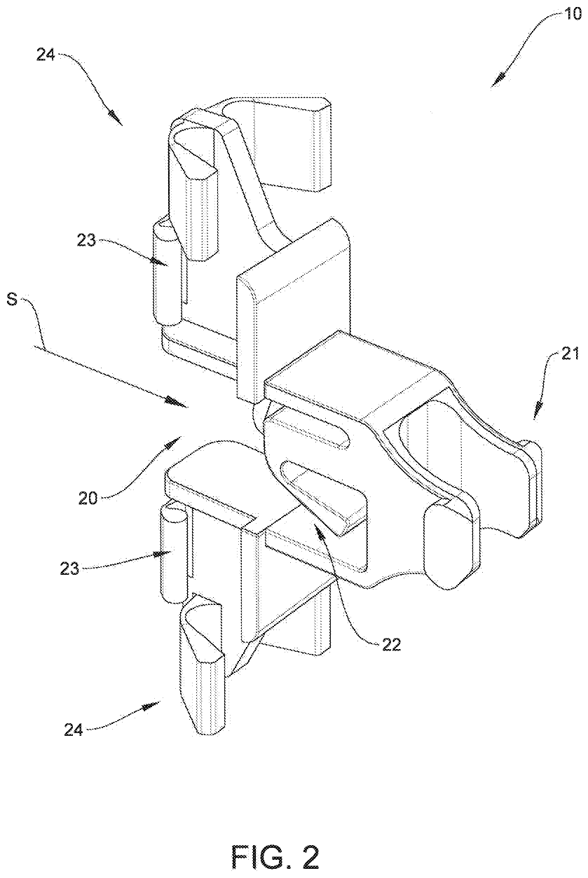

FIG. 2 shows a connecting element 10 according to a second exemplary embodiment of the present disclosure. In the embodiment example illustrated in FIG. 2, in particular in contrast to the connecting element 10 of FIG. 1a, it is provided that the first functional section 21 is not arranged in such a way that it is arranged in the end section 45 of the first furniture component 11 in the assembled state, but at the end of the connecting element 10 facing away from the visible side of the piece of furniture. In particular, it is provided by the first function section 21 in the embodiment example of FIG. 2 that engaging elements of the first functional section 21 engage in corresponding holes or recesses in the cover walls 50 of the first furniture component 12, the recesses or holes being closed, that is to say the recesses or holes are recessed into the interior of the first furniture component as seen in the plug-in direction. In particular, it is provided that the first functional section 21 is substantially resilient or elastic in a direction perpendicular to a main plane substantially spanned by the T-shaped configuration of the connecting element 10. In contrast, the resilient action of the first functional section 21 of FIG. 1a extends in a direction parallel to the main plane of the connecting element 10 defined by the T-shaped basic course of the connecting element 10. Furthermore, in contrast to the embodiment in FIG. 2, it is provided that the cover wall 50 or cover walls 50 in FIG. 1a of the first furniture component 11 are provided at the outermost periphery with a cover wall contour course 28 with which, in the assembled state, the first functional section 21 interacts positively with the respective cover wall 50 of the first furniture component 11.

Furthermore, a fourth functional section 24 is shown in the embodiment example illustrated in FIG. 2. The fourth functional section 24 is provided, in particular, for forming a fourth snap-in connection by means of which it is possible to connect a rear wall 14 of the piece of furniture. In particular, it is provided that the third functional section 23 and the fourth functional section 24 are offset with respect to the second functional section 22 along a direction parallel to the plug-in direction S and in a direction perpendicular to the plug-in direction S. In particular, the third functional section 23 and/or the fourth functional section 24 form a termination of the side of the connecting element 10 facing the visible side in the assembled state.

Furthermore, it is preferably provided that the bracket-like arm sections of the first functional section 21, the second functional section 22, the third functional section 23 and/or the fourth functional section 24 differ from each other. In this way, a corresponding force application can be set in particular serving the respective functional purpose.

Further, it is preferably provided that the second functional section 22 is formed of only a single bracket-like arm portion, since the receiving area 20 already serves as a support for the portion of the second furniture component 12 received in the receiving area 20. The bracket-like arm portion presses the second furniture component 12 against the support side of the second furniture component 12 at the receiving area 20.

It is further provided that, in a direction parallel to a main plane defined by the T-shaped path and perpendicular to the plug-in direction S, the third functional section 23 and fourth functional section 24 are arranged one above the other, in particular are arranged one above the other directly adjacent to each other.

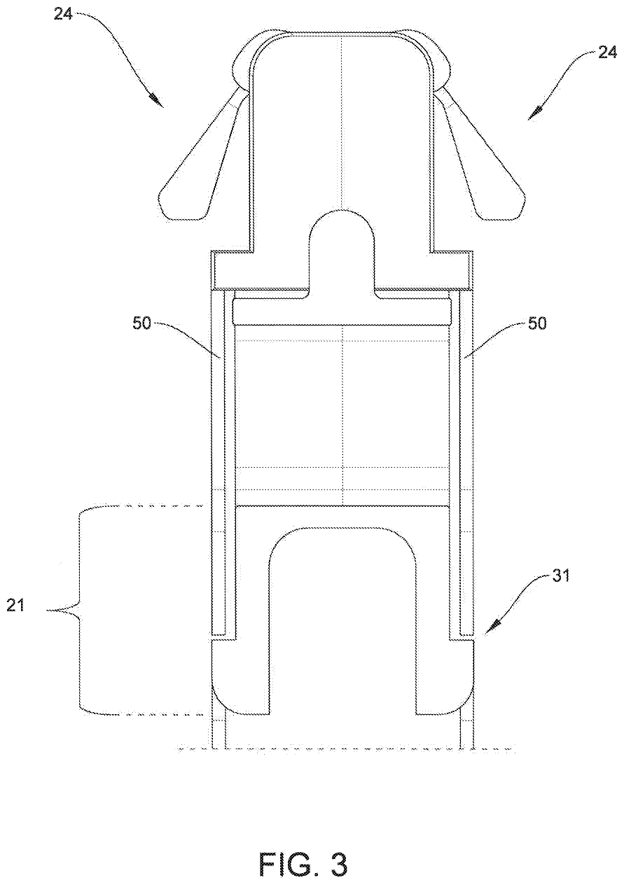

In FIG. 3, the connecting element 10 of FIG. 2 is shown in the assembled state in a sectional view. In particular, it can be seen that the hook-shaped, in particular arcuate arm sections of the first functional section 21, engage in closed cutouts in the cover walls 50 of the first furniture component 11, so as to implement a form fit between the connecting element 10 and the first furniture component 11. By a closed cutout is meant such a recess, the boundary of which is closed and has no opening at the face side St of the first furniture component 11.

Furthermore, it is preferably provided that the bracket-like arms of the fourth functional section 24 project laterally with respect to the U-shaped section of the connecting element 10, in particular in such a way that, in the assembled state, they project in a direction perpendicular to the main plane with respect to the cover walls 50 of the first furniture component 11. Thereby, it is advantageously possible to fix the rear wall 14 with the ends of the fourth functional section 24 and/or the bracket-like arm sections by means of these bracket-like arm sections of the fourth functional section 24. Therein, the bracket-like arm sections of the fourth functional section 24 embrace the rear wall 14 and fix it to the piece of furniture.

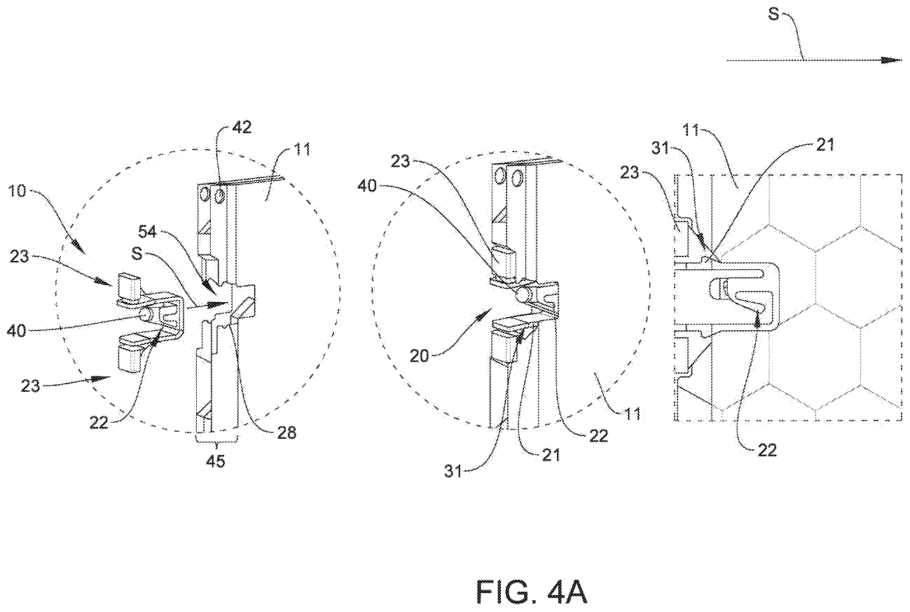

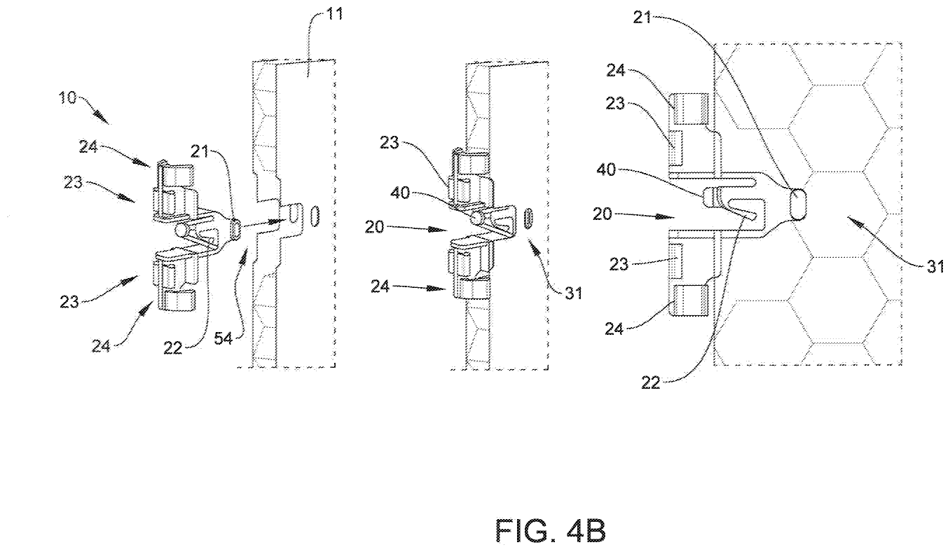

FIGS. 4a to 9 show a method for assembling or mounting a piece of furniture with a plug-in system 100 according to an exemplary embodiment of the present disclosure, in particular for the first variant shown in FIG. 1a. In particular, it is provided here that in a first step (on the left in FIG. 4a) the connecting element 10 is pushed or inserted into the first furniture component 11 along a plug-in direction S. For this purpose, a corresponding cover wall contour course 28 is provided in the cover walls 50, which is profiled in particular in such a way that it is designed to be complementary to the outer contour of the connecting element 10, in particular in its U-shaped section. In this respect, the cover wall contour course 28 interacts in a form-fitting manner, at least in sections, with the first functional section 21 which, in the illustrated embodiment example, is arranged in the end section 45 of the first furniture component 11 which, in particular, faces the visible side of the piece of furniture in the assembled state. It is further provided that a centering aid 40 is formed in the second functional section 22 of the connecting element 10, in particular in the form of a hemispherical or dome-shaped elevation on the face side of the second functional section 22 arranged in the receiving area 20. It is further provided that the cover wall contour course 28 is shaped such that the third functional section 23 of the connecting element 10 can be recessed in the first furniture component 11 and, in particular, is flush with the face side St of the first furniture component 11 facing the visible side of the piece of furniture. In particular, it is envisaged that a fourth functional section 24 is dispensed with in the connecting element 10 of FIG. 4a.

It is further provided that the second functional section 22 is arranged within the receiving area 20, in particular set back with respect to the face side St of the first furniture component 11 facing the visible side of the piece of furniture. The illustrations in the center and on the right of FIG. 4a show the connecting element 10 in the assembled state in a perspective view (center) and in a sectional view (right), the right-hand illustration showing the honeycomb structure of the transverse struts 51 of the first furniture component 11, which is in the form of a lightweight component. In particular, it is provided that the connecting element 10 cooperates with the first furniture component 11 in a form-fitting manner along a direction parallel to the plug-in direction S in the assembled state.

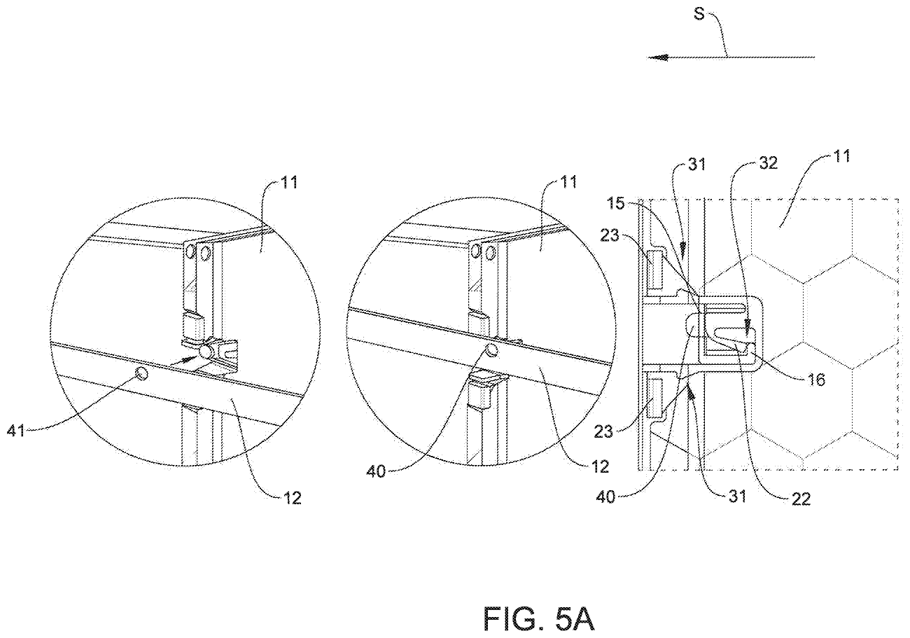

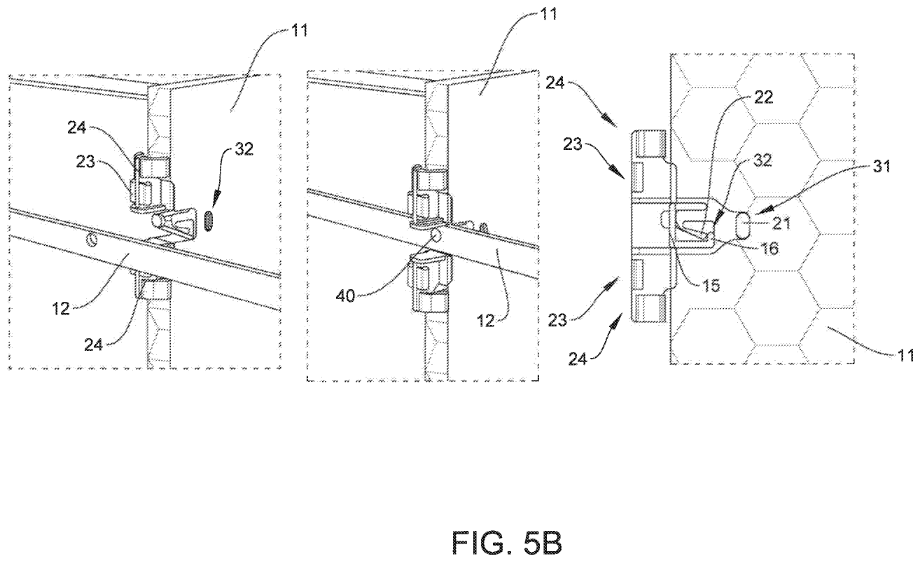

FIG. 5a shows how the second furniture component 12 is joined or assembled with the connecting element 10. For this purpose, the second furniture component 12, in particular a section of the second furniture component 12, is pushed or inserted along the plug-in direction S into the receiving area 20. During insertion, the centering aid 40 cooperates with a corresponding first recess 41 in such a way that the second furniture component 12, in particular the rail-like second furniture component 12, is fixed with respect to lateral displacement and assembly is simplified. During a plug-in movement, the second functional section 22 of the connecting element 10, which is formed in particular on the inside at the bottom of the U-shaped recess region, deforms and engages with its bracket-like arm portion behind the rear face 16 of the section of the second furniture component 12 which has been inserted into the receiving area 20. The bracket-like arm section and the rear side 16 of the second furniture component 12 then cooperate positively along a direction parallel to the plug-in direction S.

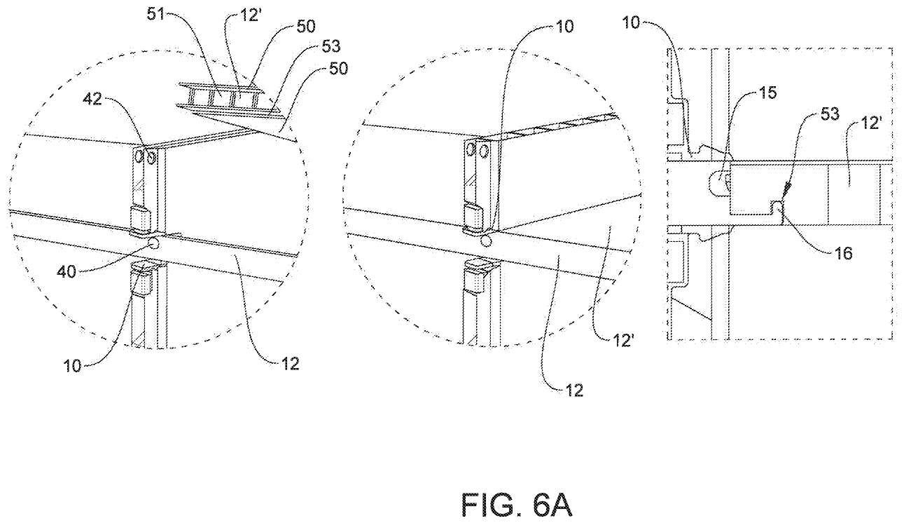

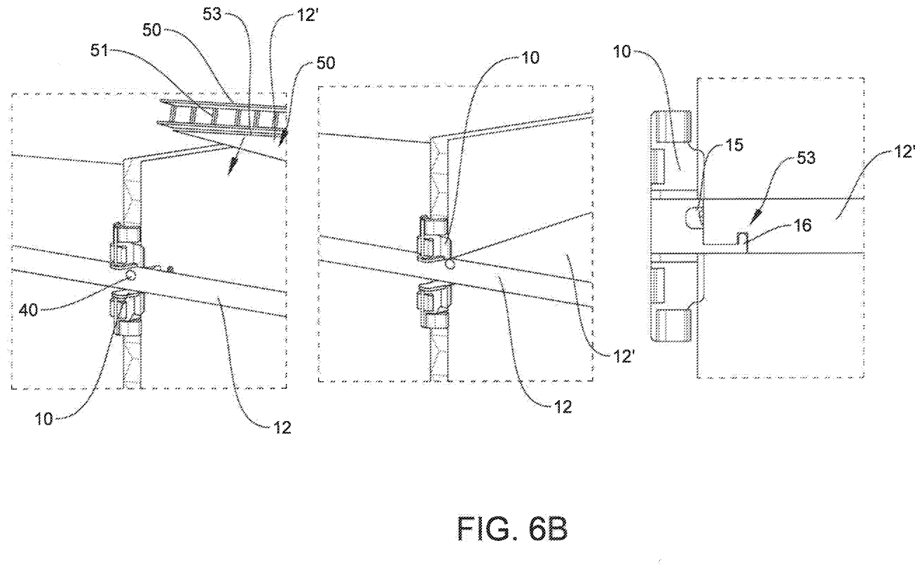

In the method steps of FIG. 6a, a shelf 12′, in particular designed as a lightweight component, is placed on the rail-like second furniture component 12. In this process, the shelf 12′ acts positively together with the rear side 16 of the second metal component 12, in particular by means of its underside or a groove 52 recessed into the underside. In this way, the shelf 12′ is fixed with respect to displacements parallel to the plug-in direction S.

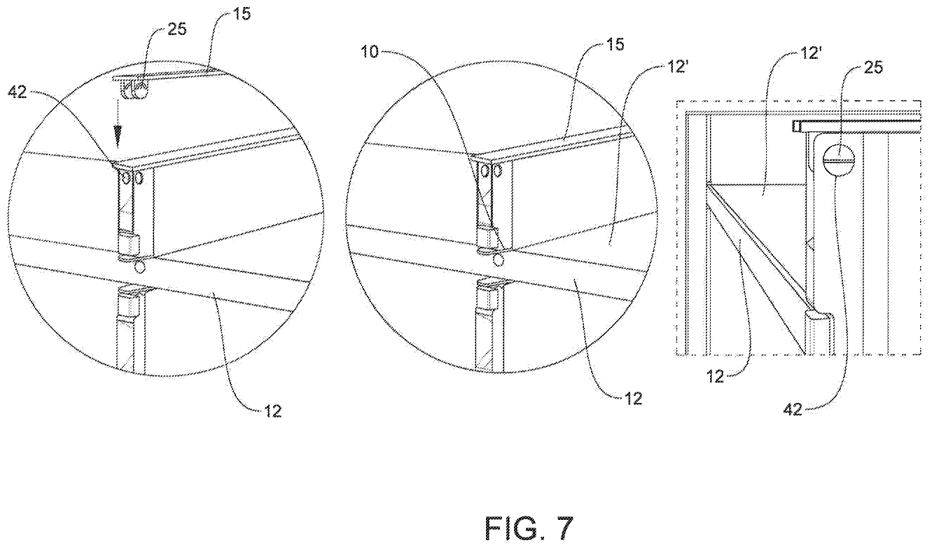

FIG. 7 shows a further cladding element 13′ which is positively connected to the end section of the first furniture component 11 via a fifth snap-in device. In particular, it is provided that the further cladding element 13′ covers or closes an upper side of the first furniture component 11. In this case, the cladding element 13 and the further cladding element 13′ are separate components, wherein in particular the cladding element 13 is provided for covering the end section 45 on the visible side of the piece of furniture, while the further cladding element 13′ is provided for covering the upper side of the first furniture component 11.

In order to cooperate with a corresponding fifth functional section 25 on the further cladding element 13′, a second cutout 42 is recessed in the end section 45, in particular at the upper end of the end section 45, in the first furniture component 11, in which cutout the corresponding fifth functional section 25 of the fifth snap-in device engages in order to cooperate positively with the end section 45.

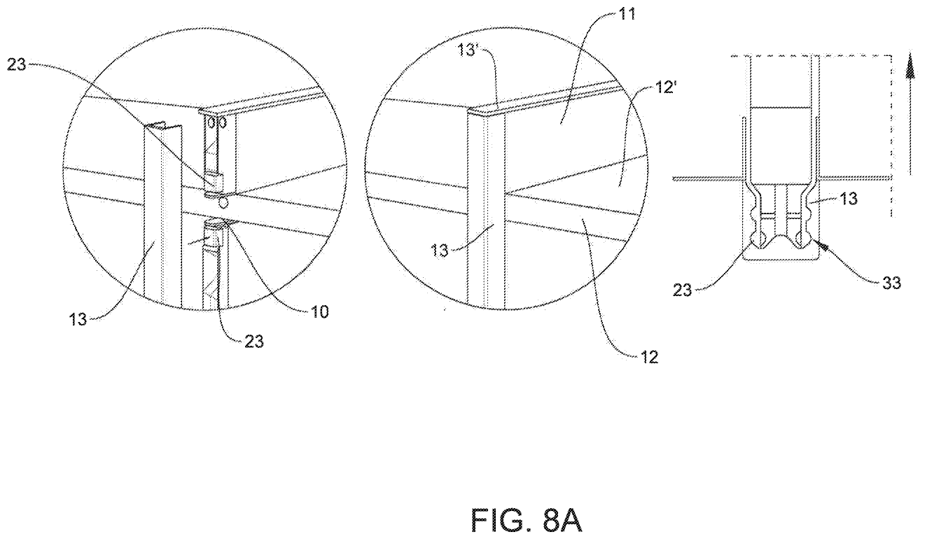

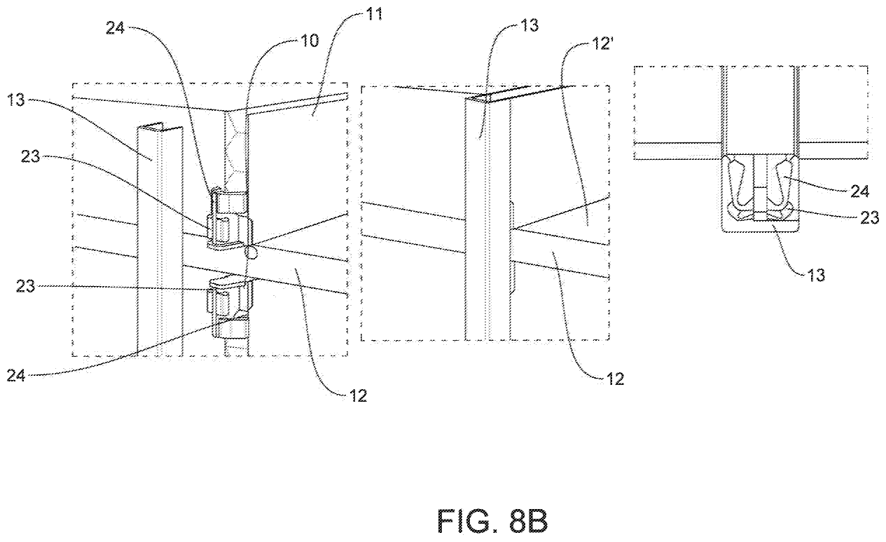

FIG. 8a shows the connection of the cladding element 13 to the connecting element 10. In this case, it is preferably provided that the connection of the connecting element 13 takes place after the connection of the further cladding element 13′, in order to thus also cover the fifth functional section 25 or the end section with the second recess 42 by the cladding element 13. The cladding element 13, which is substantially U-shaped, is plugged onto the connecting element 10 along the plug-in direction S and, with a corresponding contour course on the inner side of the U-shaped cladding element 13′, acts in a form-fitting manner together with the third functional section 23 of the connecting element 10 in a direction parallel to the stacking direction S. In this way, the cladding element 13 is mounted on the piece of furniture in an advantageous manner. In order to prevent the cladding element 10 from moving vertically, i.e. to prevent the cladding element 13 from moving up and down, it is preferably provided that the further cladding element 13″ engages over the cladding element 13 and cooperates with the cladding element 13 in a form-fitting manner on the upper side of the first furniture component 11.

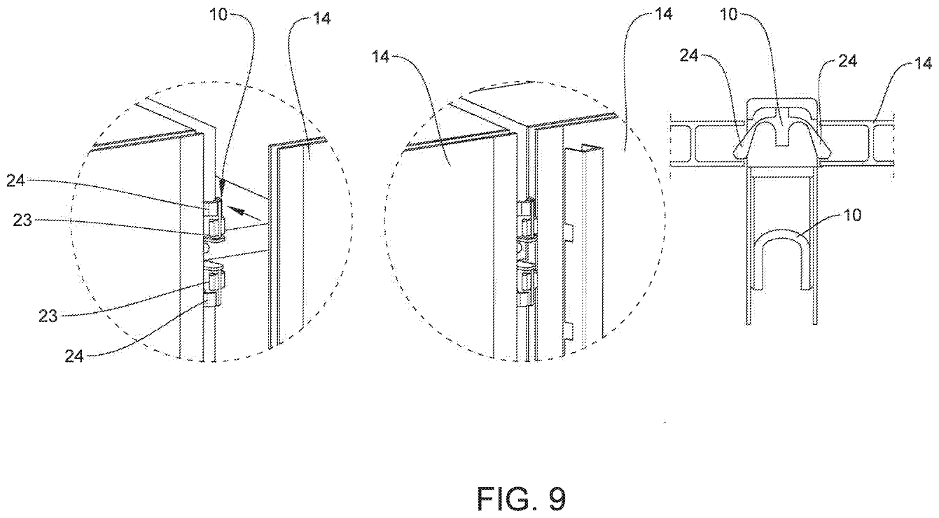

FIG. 9 shows an example of the assembly of the rear wall 14, in particular using a fourth functional section 24 on the connecting element 10. While the left-hand and central illustrations in FIG. 9 each show the connection of the rear wall 14 to the connecting element 10 in a perspective view, the right-hand illustration of FIG. 9 shows a sectional view. The sectional view reveals that the bracket-like arm sections of the fourth functional section 24 engage hollow regions in the rear wall 14, which is also formed as a light-weight component. In particular, the ends of the bracket-like arm sections of the fourth functional section 24 cooperate positively in the direction of the plug-in direction S with the cover wall 50 facing away from the visible side. Preferably, the bracket-like arm sections are dimensioned such that they extend substantially along a direction parallel to the plug-in direction S over a distance substantially corresponding to the distance between the cover walls 50, so that the rear wall 14, which is formed as a lightweight component, conceals the bracket-like arm sections and does not reveal them. This optimizes the visual impression on the rear wall 14 in an advantageous manner.

FIGS. 4b, 5b, 6b, 7, 8b and 9 show the method of assembling a piece of furniture for the second variant illustrated in FIG. 1b. In particular, the method illustrated here differs from that for the first variant, in that the fourth functional section 24 is additionally provided for fixing the third furniture component 13. In this respect, the fourth functional section 24 interacts with the inner side of the third furniture component 13 in addition to the third functional section 23. Preferably, it is provided that in the assembled state a deformation of the fourth functional section 24 is larger than the deformation of the third functional section 23. As a result, the fourth functional section 24 can advantageously support the fixation of the third furniture component 13 to the connecting element 10 by a corresponding clamping or spreading force. Moreover, the same type of connecting element 10 can be used for the front side and the rear side of the piece of furniture.

1. A connecting element for a piece of furniture for connecting a first furniture component, for example a side wall, to a second furniture component extending obliquely to the first furniture component, for example a shelf support or a shelf, without additional material-locking means and without additional fastening means, comprising:
a first functional section for a first snap-in device which, in the assembled state, forms a first form fit of the connecting element with the first furniture component,
a second functional section for a second snap-in device which, in the assembled state, forms a second form fit of the connecting element with the second furniture component
a receiving area in which, in the assembled state, a section of the second furniture component is received, and
a third functional section for a third snap-in device which, in the assembled state, forms a third form fit of the connecting element with a cladding element which covers the receiving area at least partially, preferably completely, towards a visible side of the piece of furniture, and/or a fourth functional section for a fourth snap-in device which, in the assembled state, fixes a rear wall of the piece of furniture.

2. The connecting element according to claim 1, wherein the second functional section is arranged in the receiving area.

3. The connecting element according to claim 1, wherein the connecting element is substantially T-shaped.

4. The connecting element according to claim 1, wherein the connecting element is integrally formed and in particular is made of plastic.

5. The connecting element according to claim 1, wherein the first functional section and/or the second functional section comprises at least one bracket-like arm section, preferably exactly one bracket-like arm section.

6. The connecting element according to claim 1, wherein the section of the second piece of furniture to be received is insertable into the receiving area along a plug-in direction during assembly, wherein the second functional section on the one hand and the third functional section and/or the fourth functional section on the other hand are offset relative to one another in a direction running parallel to the plug-in direction and in a direction running perpendicular to the plug-in direction.

7. The connecting element according to claim 1, wherein the connecting element comprises a centering aid for the second furniture component, wherein the centering aid is preferably formed in the second functional section.

8. A plug-in system for assembling a piece of furniture comprising
a first furniture component,
a second furniture component,
a cladding element, and
a connecting element according to one of the preceding claims, in particular a connecting element according to one of the preceding claims separate from the first furniture component and the second furniture component,
a first snap-in device which, in the assembled state, forms a form fit between the connecting element and the first furniture component,
a second snap-in device which, in the assembled state, forms a second form fit between the connecting element and the second furniture component,
a receiving area in which, in the assembled state, a section of the second furniture component is received, and
a third snap-in device which, in the assembled state, forms a form fit of the connecting element with a cladding element which covers the receiving area at least partially, preferably completely towards a visible side of the piece of furniture, and/or a fourth snap-in device which, in the assembled state, fixes a rear wall of the piece of furniture.

9. The plug-in system according to claim 8, wherein the first furniture component has two cover walls for forming a light-weight component, between which hollow spaces are formed, in particular between transverse struts which connect the two cover walls to one another, wherein the first functional area of the first snap-in connection interacts with at least one of the two cover walls in a form-fitting manner in the assembled state.

10. A method of assembling a piece of furniture, wherein a connecting element according to claim 1 is used for connecting a first furniture component and a second furniture component.
